(19) United States
(12) Patent Application Publication
(10) Pub. No.: US 2003/0144974 A1
(43) Pub. Date: Jul. 31, 2003

(54) Self organizing learning petri nets

(75) Inventors: Seung-gi Chang, Seoul (KR); Zhi-ming Zhang, Suwon-city (KR)

Correspondence Address: STAAS & HALSEY LLP, 700 11TH STREET, NW, SUITE 500, WASHINGTON, DC, 20001, US

(73) Assignee: Samsung Electronics Co., Ltd., Suwon-city (KR)

(21) Appl. No.: 10/350,177

(22) Filed: Jan. 24, 2003

(30) Foreign Application Priority Data
Jan. 31, 2002 (KR) 2002-5749

(51) Int. Cl. G06F 15/18; G06N 3/08; G05B 13/02; G05B 21/02

(52) U.S. Cl. 706/25; 700/47; 700/73

(57) ABSTRACT

A self organizing learning Petri net modeling a system using a large number of training samples performs consecutive trainings using the training samples with a pre-known output value with respect to an input, and when following training samples are applied to a first system parameter created by pre-tested training samples, begins to create the system according to a method of creating a distinct system parameter when an error between an output value of the system and a pre-known output value of the following training samples is larger than a critical value, and adding the new system parameter to a pre-organized first system parameter. A final system parameter is determined by consecutively learning the large number of the training samples in an organized system again. Through this self organizing process, system modeling can be performed more accurately, and a learning process much faster than a back-propagation learning process using a unified CPN and LPN in a general neural network can be achieved.

### CROSS-REFERENCE TO RELATED APPLICATIONS

This application claims the benefit of Korean Patent Application No. 2002-5749, filed Jan. 31, 2002, in the Korean Intellectual Property Office, the disclosure of which is incorporated herein by reference.

### BACKGROUND OF THE INVENTION

1. Field of the Invention

The present invention relates to a Petri network, and more particularly, to a learning Petri net capable of modeling a system using a large number of training samples.

2. Description of the Related Art

Recently, soft computing models, such as neural networks, wavelet networks, fuzzy systems, Bayesian classifiers, and fuzzy partitions, are widely used in various fields. Although started on a different basis, these soft computing models are gradually being recognized that they are similar and inter-connectable to each other. For example, a RBF (Radial Basis Function Network) and a class of a fuzzy system are regarded as functionally identical. Having a functional equivalence, a WRBF (Weighted Radial Basis Function) network unifying a neural network, a wavelet network, a fuzzy system, and other traditional methods, such as linear controllers or fuzzy and hard clusters, is provided (Leonardo M. Reyneri, “Unification of neural and wavelet networks and fuzzy systems,” IEEE trans. on neural networks, Vol. 10, No. 4, pp. 801-814, 1999). The WRBF network suggested by Leonardo M. Reyneri has an ability to merge all technologies of the neural network, the wavelet network, the fuzzy system, and other traditional methods within the same system together with unified controlled and uncontrolled training algorithms.

Meanwhile, Carl Petri of Germany suggested Petri nets capable of modeling various conditions in 1960. A Petri net includes two types of nodes, which are places and transitions and connected to other types of nodes through an arc. A transition is called a function generating an output signal in response to an input signal, and a place is a space storing particular input/output signals. A place is marked with a token and acquires a meaning through a location mark and a firing rule. The firing rule is that transfer is possible only when all input plates in the transition have at least one token and the transition can be fired when the transfer becomes possible. When the transition is fired, each input place of the transition loses the token, and each output place of the transition earns another token. In other words, the tokens in the Petri net can transfer through fired transitions. It means that tokens can be transferred via a particular route instead of all network routes and the Petri net has a capability of a distribution function.

However, until recently, the Petri net has been regarded merely as a graphical and mathematical modeling tool applicable to a domain completely different from a soft computing area. That is because the Petri net is hardly found in a case where it is applied to modeling and controlling of a nonlinear dynamic system and has no learning ability unlike a neural network.

In order to solve the above problem, a new style Petri net having a learning ability, called a learning Petri net (LPN), is suggested recently (Kotaro Hirasawa, et al., “Learning Petri network and its application to nonlinear system control,” IEEE Trans. Syst. Man Cyber, Vol. 28, No. 6, pp. 781-789, 1998).

FIG. 1 is a diagram showing a basic learning structure of a conventional LPN. Each transition excluding an input transition in FIG. 1 has a predetermined number of input and output places. Each different transition is regarded as not having the input and output places at the same time for simplicity. Although FIG. 1 shows a limited number of transitions and places in practice, more transitions and places may be connected with each other in rows or series in a larger variety of forms.

In order for the LPN to have a characteristic of a dynamic system, a firing signal is introduced to the LPN. The firing signal is processed in a fired transition and propagates in a network through a token transfer. When the firing signal is assigned in the input transition together with a value of an input signal, and an output signal is earned as the firing signal of the output transition, the LPN can be used to realize an input/output mapping. Meanwhile, input arcs connecting the input places with the transition have weights, hᵢⱼ. The weights constrained to be positive integers in a general Petri net are extended to be continuously adjustable in order to obtain the learning ability. Output arcs connecting the transitions with the output places have time delays, Dⱼₖ, which are zero or a positive integer at a sampling time.

In the LPN, the input/output mapping is realized by the firing signal propagating from the input transition to the output transition through the token transfer. The LPN and the Petri net are discrete in a way that the tokens transfer the firing signals in the LPN. The tokens in the LPN are generated in a transition and provided with a value of the firing signal of the transition until the tokens are extinguished in the place. The value of the firing signal of the transition can be defined as the following equation 1.

$$h ( {T}_{j} , t ) = f ( {ς}_{j} ) \\ {ς}_{j} = {\sum }_{i} h ( {P}_{ij} , t ) {h}_{ij} + {β}_{j} ) \qquad EQUATION 1$$

where hᵢⱼ is a firing weight on an arc between a place Pᵢⱼ and a transition Tⱼ, i is an index of a place connected to an input side of the transition Tⱼ, βⱼ is a threshold value for the transition Tⱼ, ƒ(ζⱼ) is a nonlinear function, and h(Pᵢⱼ,t) is a value of the firing signal of the place at time t defined by a sum of values of the firing signal transferred by tokens in the place. When the place is empty, h(Pⱼ,t) is given a value of zero.

Although the LPN can have an ability to learn and realize the neural network, it is different to the neural network as it has a capability of a distribution function and at the same time parameters of the LPN are determined by experiences of an expert as in normal neural networks.

However, there was a problem that the output value may be more or less inaccurate because a number of connections of all transitions and places between an input layer and an output layer are predetermined by the experiences of a user in the conventional LPN. That is, in [the] a real application of the LPN, a problem may occur since a whole system needs to be modified in relation to a degree of an error of an output value as an accuracy of the output value lacks when a structure suitable for the application does not exist, although an accurate output may be expected when it does.

### SUMMARY OF THE INVENTION

An object of the present invention for solving the above and other problems is to provide a self organizing learning Petri net capable of obtaining most suitable parameters of the net from input samples and improving a capability of a fast learning speed and a more accurate modeling.

Additional objects and advantageous of the invention will be set forth in part in the description which follows and, in part, will be obvious from the description, or may be learned by practice of the invention.

A self organizing learning Petri net (SOLPN) to achieve the above and other objects includes training a large number of training samples with a pre-known output value in relation to an input, comparing an error between an output value created by applying following training samples to a first system parameter produced by a pre-tested training sample and a pre-known output value of the following training samples with a critical value, creating a separate system parameter when the error is bigger than the critical value, self organizing an initial system by creating a new other system by adding the separate system parameter to the first system parameter, and determining a final system parameter through consecutive learning of the large number of the training samples in an initial system established based on an initial system parameter.

The self organizing of the initial system parameter includes determining the first system parameter through a first training sample among the large number of the training samples, applying a second training sample to a first system organized through the first system parameter, comparing a second error produced as a result of applying the second training sample to the first system with a second critical value, and creating a second system parameter organizing a second system when the second error is larger than the second critical value after comparison. When the second error is smaller than the second critical value after comparison, the self organizing learning Petri net further includes applying the following training sample to the first system. When the second error is larger than the second critical value after comparison, it further includes applying the following training sample to the second system. The initial system parameter is determined by repeating consecutive training of the large number of the training samples a predetermined number of times.

The determining of the final system parameter includes consecutively applying the large number of the training samples to the initial system organized by the initial system parameter, comparing each basic error created in the large number of the training samples with each basic critical value, and amending the final system parameter determined by preceding training samples when the basic error is larger than the basic critical value after comparison, and the large number of consecutive training is repeated until the final system is stabilized.

Since the self organizing learning Petri net according to the present invention performs the learning not through the system learning by a user's experience but through the system created by the sample training, a learning process becomes faster and more accurate modeling can be achieved.

### BRIEF DESCRIPTION OF THE DRAWINGS

These and other objects and advantageous of the invention will become apparent and more readily appreciated from the following description of the preferred embodiments, taken in conjunction with the accompanying drawings of which:

FIG. 1 is a diagram of a conventional basic LPN structure;

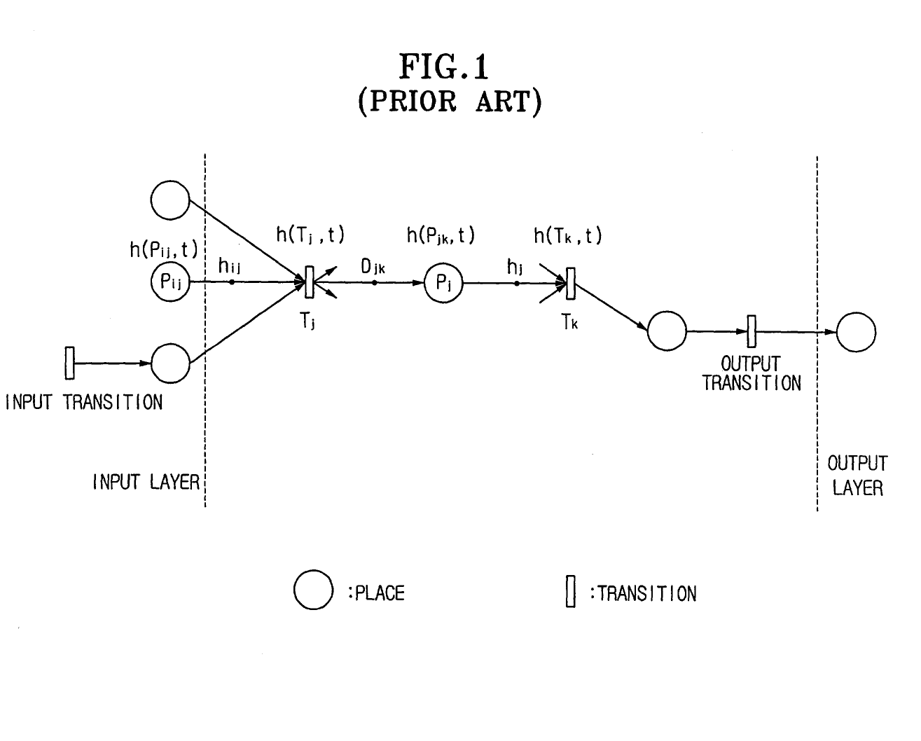

FIG. 2 is a diagram of a 2-input self organizing learning Petri net (SOLPN) structure according to an embodiment of the present invention;

FIG. 3 is a flowchart describing a self organizing process of the SOLPN shown in FIG. 2; and

FIG. 4 is a flowchart describing a learning process of the SOLPN shown in FIG. 2.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described in order to explain the present invention by referring to the figures.

In describing the present invention, cited reference papers are listed at the end of the “Description of the preferred embodiment” with numbers. Each number is marked in round brackets, ( ), and, hereinbelow, descriptions of some technologies will be replaced by providing the number of the relevant reference paper.

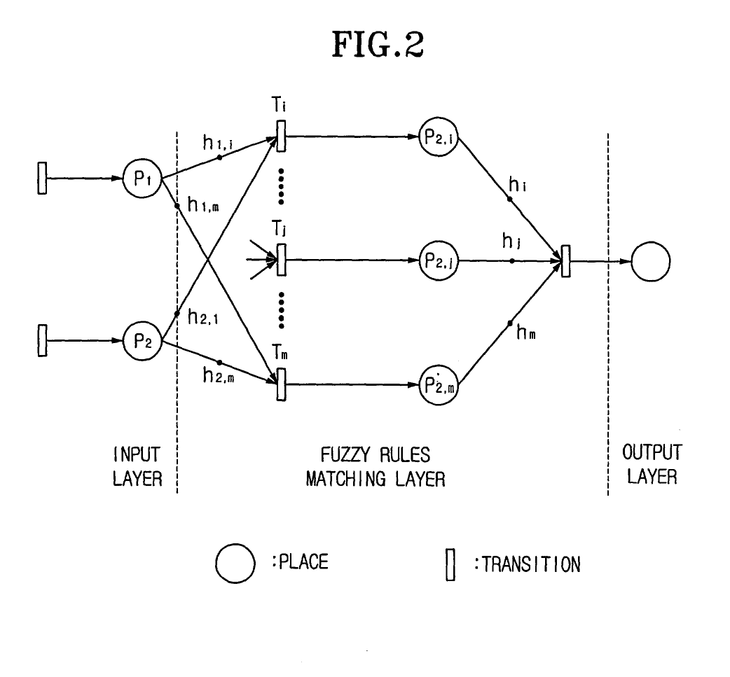

FIG. 2 is a diagram of a 2-input self organizing learning Petri net (SOLPN) structure according to an embodiment of the present invention. The SOLPN has an input layer, a fuzzy rules matching layer, and an output layer.

The input layer has two input transitions and two input places.

The fuzzy rules matching layer may have a number of transitions and a number of places. In the fuzzy rules matching layer, signals propagate based on the following Equation 2.

$$h ( {T}_{j} , t ) = exp ( - \frac{{\sum }_{i = 1}^{{n}_{1}} {( h ( {P}_{i , j} , t ) - {h}_{ij} )}^{2}}{{σ}_{j}^{2}} ) \qquad EQUATION 2$$

where hᵢⱼ is a firing weight on an arc between a place Pᵢⱼ and a transition Tⱼ, i is an index of a place connected to an input side of the transition Tⱼ, and h(Pᵢⱼ,t) is a value of a firing signal of the place at time t defined by a sum of values of the firing signal transferred by tokens in the place. When the place is empty, h(Pᵢⱼ,t) is given a value of zero. σ is a first system parameter. Exp( ) is an exponential function. In practical application, h(Tⱼ,t) can be any kind of suitable nonlinear functions, and it is not limited just to exponential function.

The output layer has a single transition and a single place to obtain a single output. In the output layer, signals propagate based on the following Equation 3.

$$h ( {T}_{j} , t ) = \frac{{\sum }_{i = 1}^{{n}_{1}} h ( {P}_{i , j} , t ) \cdot {h}_{ij}}{{\sum }_{i = 1}^{{n}_{1}} h ( {P}_{i , j} , t )} \qquad EQUATION 3$$

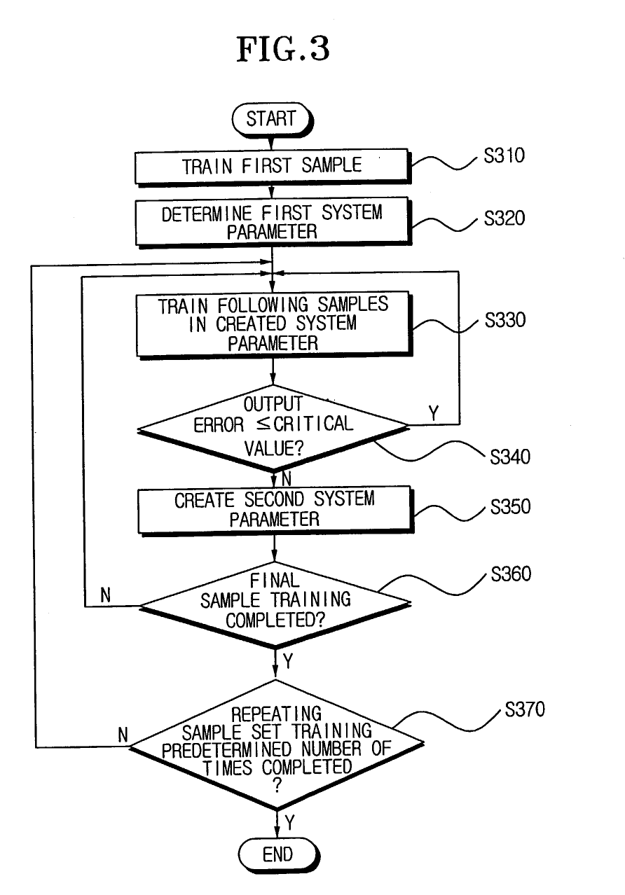

FIG. 3 is a flowchart describing a self organizing process of the SOLPN shown in FIG. 2. In order to establish a system, first of all, a first training sample of a sample set of which an input value and an output value are already known is consecutively trained in operation S310. That is, after establishing a first system parameter through the first training sample in operation S320, a second training sample of the sample set is trained in the system established by the first system parameter in operation S330. And then an error between an output value of the system according to the second training sample and the already-known output value of the second training sample is produced and compared with a critical value. If the error is smaller than the critical value, a third training sample of the sample set is consecutively trained in the system. On the other hand, if the error is bigger than the critical value, a second system parameter is produced according to the second training sample in operation S350.

For the following training samples consecutively input to the system, a new system parameter is produced according to the error between the output value of the system according to the second training sample or the following training samples and the already-known output value of the second training sample or the following training samples which are continuously trained in the predetermined system parameter. Finally, after detecting a training completion status of a last sample in operation S360, the self organizing process is completed by repeating the consecutive training of the training samples a predetermined number of times in operation S370. The following training samples are applied to the new system parameter created by a combination of a pre-system parameter established by a pre-tested training sample, a following system parameter, and a previous system parameter.

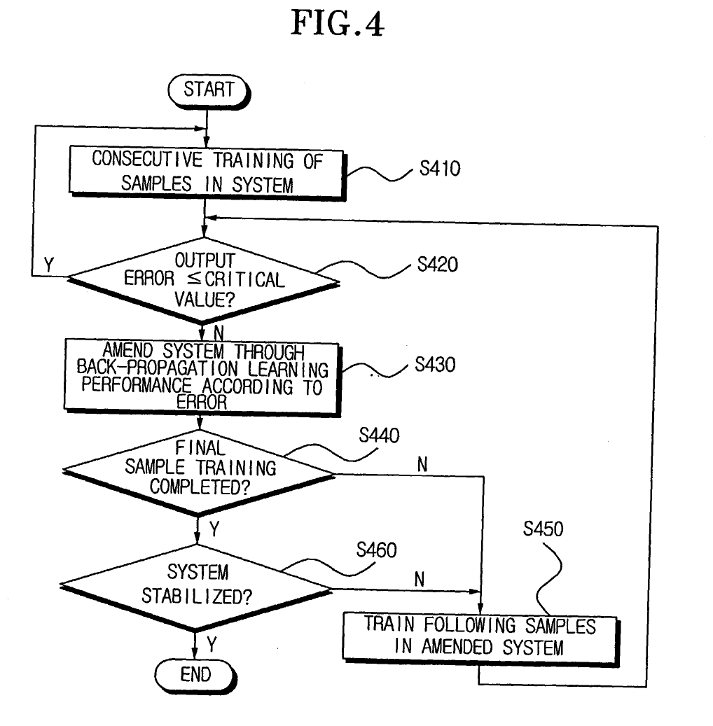

FIG. 4 is a flowchart describing a learning process (i.e. an optimization phase) of the system self organized through the above process. First of all, the first sample in the system self organized through the self organizing process shown in FIG. 3 is trained in operation S410. The error between the output value of the system as a training result and the output value of the already-known training sample is obtained and compared to the critical value in operation S420. If the error is smaller than the critical value, the second sample is trained. On the other hand, if the error is bigger than the critical value, the system is amended through back propagation learning in operation S430. The following samples are trained in the amended system in operation S440. Through the above described processes, completion of a last sample training is detected in operation S440, and training of the sample sets is consecutively repeated until the system is stabilized in operation S450. When the system is stabilized by the training samples, the learning by the training samples is ended in operation S460.

Hereinafter, the above self organizing and learning processes are re-described referring to the cited papers.

The present invention utilizes a self-organizing counter propagation network (SOCPN) equation shown in reference paper (15) in order to establish a system. In a simple case, an improved unsupervised SOCPN (IUSOCPN) employing a flexible fuzzy division is used for sampling information from training data shown in reference papers (4), (15). The IUSOCPN may be used as an example of a system self organizing phase of the system.

A system self organizing process based on the above IUSOCPN is as the following:

At first, as a first operation, a winner unit, J, having a minimum distance D between the space and the transition in the fuzzy rules matching layer in relation to a current input, \overline{x}, is determined by Equation 4.

$$D ( {\overline{H}}^{j} ( t ) , \overline{x} ) = {min}_{j = 1 , … , M} {d}^{j} ( \overline{H} ( t ) , \overline{x} ) \qquad EQUATION 4$$

where \overline{H}^{j}(t)=(h₁ⱼ(t), . . . ,h_{Qj}(t)), Q is a dimension of the current input \overline{x}, and d(•,•) is a metric distance.

In equation 4, d(•,•) can be defined as [the] a Euclidean distance as in equation 5 below:

$${d}_{Euc}^{j} ( \overline{x} , {\overline{H}}^{j} ) = {[ {\sum }_{i = 1}^{Q} {( {h}_{ij} - {x}_{i} )}^{2} ]}^{1 / 2} \qquad EQUATION 5$$

In a second phase, a winner is determined using the following rules:

If D(\overline{H}^{J}(t),\overline{x})≦δ, then the unit J is the winner. If D(\overline{H}^{J}(t),\overline{x})>δ, then create a new unit. δ is a predefined system parameter.

In a third phase, if J is the winner according to the above rules, a parameter equal to equation 6 is maintained.

$$\{ \begin{matrix} {n}^{j} ( t ) = {n}^{J} ( t - 1 ) + 1 {α}^{J} ( t ) = \frac{1}{{n}^{J} ( t )} \\ {δ}^{J} = {δ}^{J} + η \\ {\overline{H}}^{J} ( t ) = {\overline{H}}^{J} ( t - 1 ) + {α}^{J} ( t ) [ \overline{x} - {\overline{H}}^{J} ( t - 1 ) ] \\ p ( t ) = P ( t - 1 ) \\ {z}^{J} = 1\end{matrix} \qquad EQUATION 6$$

If the new unit is created, the parameter is amended as equation 7 below:

$$\{ \begin{matrix} p ( t ) = P ( t - 1 ) \\ {\overline{ H}}^{P} ( t ) = \overline{x} \\ {δ}^{P} = δ \\ {n}^{P} ( t ) = 1 \\ {z}^{P} = 1\end{matrix} \qquad EQUATION 7$$

0<a^{J}(t)<1 is a gain sequence decreasing together with time, and η is a constant expansion rate.

In a fourth phase, once the fuzzy rules matching layer is stabilized through the processes above, \overline{M}^{J} becomes fixed, and an output layer starts to learn a desired output y^{s} for each fixed weight vector by adjusting a connection weight hⱼ from a J th fuzzy rule unit to an output unit. An update formula at the output layer is as Equation 8 below:

hⱼ(t)=hⱼ(t−1)+β[y−hⱼ(t−1)]z^{j} EQUATION 8

An update rate β is a constant within a range between 0 and 1, and y is a corresponding pre-known output.

One thing to note is that all K(K>1) number of transitions will be fired at [the] a normal performance phase or the optimization phase of the SOLPN, whereas only one transition is fired in the self organizing process. It means that the number of firing transitions is limited to one in the self organizing phase and the K number of the transitions will be fired in the normal learning performance or the optimization phase. In other words, the number of the firing transitions is different in each phase. In addition, fixing the number of the firing transitions as one makes a calculation in the self organizing phase (process) convenient.

A general structure of a fuzzy system given by a determination of the number of rules gains an initial parameter of the system through the above described self organizing process. However, the system can be regarded as a rather rough model and is not sufficient to be an accurate modeling. Therefore, in the present invention, a unified learning algorithm for a weighted radial basis function (WRBF) network based on a gradient descendent method is used. A normal supervised gradient descendent method for the WRBF network is shown in reference paper (17).

An error function is defined in the following Equation 9:

$$E ( \overline{X} ; \underline{C} , \underline{W} , \overline{Θ} ) = \frac{1}{2} {\sum }_{j} {( {y}_{j} - {t}_{j} )}^{2} \qquad EQUATION 9$$

where yⱼ and tⱼ are a response of a J th neuron to the input \overline{x} and a corresponding target value taken from the training sample set, respectively. Generalized learning rules for a WRBF neuron are as the below equations 10 through 14:

$${δ}_{j} = \frac{\partial E}{\partial {y}_{i}} = ( {y}_{j} - {t}_{j} ) \qquad EQUATION 10$$

$$\begin{matrix}\begin{matrix}Δ {w}_{ji} = - {η}_{w} \cdot {δ}_{j} \cdot \frac{\partial E}{\partial {w}_{ji}} \\ = - {η}_{w} \cdot {δ}_{j} \cdot {F}^{′} ( {z}_{j} ) \cdot [ \frac{{z}_{j}}{{n ( {z}_{j} )}^{n}} ]\end{matrix} & EQUATION 11 \\ {ΔΘ}_{j} = - {η}_{Θ} \cdot {δ}_{j} \cdot {F}^{′} ( {z}_{j} ) \cdot [ \frac{{z}_{j}}{{n ( {z}_{j} )}^{n}} ] & EQUATION 12 \\ Δ {c}_{ji} = ( {η}_{c} \cdot {δ}_{j} \cdot F ( {z}_{j} ) \cdot [ \frac{{z}_{j}}{{n ( {z}_{j} )}^{n}} ] \cdot \begin{matrix}{w}_{ji} \cdot [ n \cdot {D}_{n - 1} ( {x}_{i} - {c}_{ji} ) \cdot sgn ( {x}_{i} - {c}_{ji} ) \cdot {x}_{i} - {c}_{ji} ) ]\end{matrix} & EQUATION 13 \\ δ {x}_{i} = {\sum }_{j} {δ}_{j} \cdot {F}^{′} ( {z}_{j} ) \cdot [ \frac{{z}_{j}}{{n ( {z}_{j} )}^{n}} ] \cdot {w}_{ji} \cdot [ n \cdot {D}_{n - 1} ( {x}_{i} - {c}_{ji} ) \cdot sgn ( {x}_{i} - {c}_{ji} ) & EQUATION 14\end{matrix}$$

where η_{w}, η_{c}, and η_{Θ} are the three learning coefficients and zⱼ is an argument of an active function, F(•). δⱼ is a back-propagated learning error at an input normalization layer.

In the above system optimization phases, the present invention has two differences from the WRBF learning algorithm. A first difference is that not all parameters are optimized in the whole network. This is because only the K number of the transitions is fired according to LPN firing rules. The first difference enables a process time in the learning phase to be reduced. A second difference is that the gradient descendent method is basically slow. However, the parameters have been “intelligently” initialized in the self organizing process having “intelligence.” In order to further optimize a result of the system, another method described in reference paper (12) is used. The method described in the reference paper (12) utilizes a concept of decreasing errors and Equation 15.

ƒₘ₊₁=θƒₘ+(1−θ)dₘ EQUATION 15

where dₘ is a partial derivative of an error in relation to a weight at an epoch m, and θ is a learning constant.

A learning rate for the weight, an equation governing [the] a changing value e may be written as below:

$${e}_{m} = \{ \begin{matrix}{e}_{m - 1} + k & {d}_{m} {f}_{m} > 0 \\ {e}_{m - 1} \times ∅ & {d}_{m} {f}_{m} \leq 0\end{matrix} \qquad EQUATION 16$$

where k, and φ are learning constants.

When e is determined, an actual weight change cₘ is amended as following Equation 17:

cₘ=−eₘdₘ EQUATION 17

Bibliography and the reference papers are as follows.

(1) J. E. Box, G. M. Jenkins, Time series analysis: Forecasting and control, Holden Day Press, San Francisco, 1970.

(2) Ching-Chang Wong, Shyang-Ming Her, “A self-generating method for fuzzy system design,” Fuzzy Sets Syst., Vol. 103, pp. 13-15, 1999.

(3) Yin Wang, Gang Rong, “A self-organizing neural-network-based fuzzy system,” Fuzzy Stes Syst., Vol. 103, pp. 1-11, 1999.

(4) Junhong Nie, “Constructing fuzzy model by self-organizing counterpropagation network,” IEEE trans. Syst. Man Cyber., Vol. 25, No.6, pp.963-970, 1995.

(5) R. M. Tong, “The evaluation of fuzzy model derived from experimental date,” Fuzy Sets Syst., Vol. 4, pp. 1-12, 1980.

(6) W. Pedrycz, “An identification algorithm in fuzzy relational systems,” Fuzzy Sets Syst., Vol. 4, pp. 153-167, 1984.

(7) C. W. Wu, Y. Z. Lu, “Fuzzy model identification and self-learning for dynamic systems,” IEEE Trans. Syst Man Cyber., Vol. 17, pp. 683-689, 1987.

(8) M. Sugeno, T. Ysdukawa, “A fuzzy logic-based approach to qualitative modeling,” IEEE Trans. Fuzzy Syst. Vol. 1, pp. 7-31, 1993.

(9) S. Horikawa, T. Furuhashi, Y. Uchikawa, “A fuzzy modeling using fuzzy neural networks with the back-propagating algorithms,” IEEE Trans. Neural Networks, Vol. 3, No. 5, pp. 801-806, 1992.

(10) C. T. Lin, C. S. G. Lee, “Neural-network-based fuzzy logic control and decision system,” IEEE Trans. Comput., Vol. 40, No. 12, pp. 1320-1336, 1991.

(11) Teuvo Kohonen, et al., “Engineering applications of the self-organizing map,” Proc. Of IEEE, Vol. 84, No. 10, pp. 1358-1383, 1996.

(12) Murray Smith, Neural networks for statistical modeling, Van Nostrand Reinhold, New York, 1993.

(13) Petri Vuorimaa, “Fuzzy self-organizing map,” Fuzzy Sets Syst., Vol. 103, pp. 223-231, 1994.

(14) R. Hecht-Neilsen, “Counterpropagation network,” Applied Optics, Vol. 26, pp. 4979-4984, 1987.

(15) Zhiming Zhang, et al., “An improved self-organizing CPN-based fuzzy system with adaptive back propagation algorithm,” Fuzzy sets and systems, to be published.

(16) YanQing Zhang, et al., “Compensatory neurofuzzy systems with fast learning algorithms,” IEEE trans. neural networks, Vol. 9, No. 1, 1998.

(17) Leonardo M. Reyneri, “Unification of neural and wavelet networks and fuzzy systems,” IEEE trans. on neural networks”, Vol. 10, No. 4, pp. 801-814, 1999.

(18) Kotaro Hirasawa, et al., “Learning Petri network and its application to nonlinear system control,” IEEE Trans. Syst. Man Cyber., Vol. 28, No. 6, pp. 781-789, 1998.

(19) J. S. R. Jang and C. T. Sun, “Functional equivalence between radial basis function networks and fuzzy inference systems,” IEEE trans. on neural networks, Vol. 4, pp. 156-159, 1993.

(20) L. M. Reyneri, “Weighted radial basis functions for improved pattern recognition and signal processing,” Neural processing letter, Vol. 2, No. 3, pp. 2-6, 1995.

(21) L. M. Reyneri, “Unification of neural and fuzzy computing paradigms,” Proceedings of 1^{st} international symposium on neuro-fuzzy systems, AT'96, Lausanne, Switzerland, August 1996.

(22) J. M. Benitez, J. L. Castro and I. Requena, “Are artificial neural network black boxes?” IEEE trans. on neural networks, Vol. 8, pp. 1156-1164, 1997.

(23) J. J. Buckley, Y. Hayashi, and E. Czogala, “The equivalence of neural nets and fuzzy expert systems,” Fuzzy Sets Syst., No. 53, pp. 129-134, 1993.

(24) K. J. Hunt, R. Haas and M. Brown, “The functional equivalence of fuzzy inference systems and spline-based networks,” Int. J. Neural sys., 1995.

(25) T. Murata, “Petri Nets: Properties, analysis and applications,” Proc. IEEE, Vol. 77, No. 4, pp. 541-580, 1989.

(26) R. David and H. Alla, “Petri nets for modeling of dynamic systems-A survey,” Automatica, Vol. 30, No. 2, pp. 175-202, 1994.

The SOLPN according to the present invention can model a system more accurately and perform learning much faster than the back-propagation learning using a unified CPN and LPN in a general neural network by enabling a system to be self organized through training data.

Although the preferred embodiments of the present invention have been described, it will be understood by those skilled in the art that the present invention should not be limited to the described preferred embodiments. Various changes and modifications can be made within the sprit and scope of the present invention as defined by the appended claims and their equivalents.

What is claimed is:

1. A method in a self organizing learning Petri net, the method comprising:
training a number of training samples with a pre-known output value by comparing an error between an output value created by applying following training samples to a first system parameter produced by a pre-tested training sample and the pre-known output value of the following training samples, with a critical value, and by self organizing an initial system parameter according to a result of the comparing the error with the critical value; and
determining a final system parameter through consecutive learning of the number of the training samples in a system established based on the initial system parameter.

2. The method of claim 1, wherein the self organizing of the initial system parameter comprises:
determining the first system parameter through a first training sample among the number of the training samples;
applying a second training sample in a first system organized through the first system parameter;
comparing an error produced as a result of applying the second training sample to the first system and the critical value; and
creating a second system parameter when the error is larger than the critical value.

3. The method of claim 2, further comprising:
applying the following training sample to the first system when the error is smaller than the critical value.

4. The method of claim 3, further comprising:
creating a new second system parameter when the error is larger than the critical value;
organizing a new third system parameter by adding the second system parameter to the first system parameter; and
applying a following training sample to the third system.

5. The method of claim 1, wherein the initial system parameter is determined by repeating consecutive training of the number of the training samples a predetermined number of times.

6. The method of claim 1 wherein the determining of the final system parameter comprises:
consecutively applying the number of the training samples to the system organized by the initial system parameter:
comparing each error created in each of the training samples with each basic critical value; and
amending a system parameter determined by preceding training samples when the error is larger than the critical value.

7. The method of claim 6, wherein the final system parameter is determined by repeating consecutive training of the training samples until the system is stabilized.

8. A method in a self organizing learning Petri net (SOLPN), the method comprising:
forming a first system parameter from a first training sample;
applying a second training sample having a pre-known output value to a system formed by the first system parameter to generate an output;
generating an error between the output of the system according to the second training sample and the pre-known output value of the second training sample;
comparing the error with a first critical value; and
creating a second system parameter forming the system when the error is greater than the first critical value.

9. The method of claim 8, further comprising:
applying a third training sample having another pre-known output value to the system formed by the second system parameter to generate a second output;
generating a second error between the second output and another pre-known output value;
comparing the second error and a second critical value; and
creating a third system parameter forming the system when the error is greater than the second critical value.

10. The method of claim 8, further comprising:
determining whether the second training sample is a final training sample; and
applying a third training sample to the system formed by the first system parameter when the second training sample is not the final training sample.

11. The method of claim 10, further comprising:
completing a self organizing process when the second training sample is the final training sample.

12. The method of claim 8, wherein the creating of the second system parameter comprises:
amending the system to a second system formed according to a back-propagating learning process; and
applying a third training sample to the second system.

13. The method of claim 8, wherein the SOLPN comprises a first sample set having the first and second training samples and a second sample set having third and fourth training samples having third and fourth pre-known output values, respectively, and the method further comprises:
determining whether the second training sample is a final training sample in the first sample set; and
applying the third training sample to the system formed by the second system parameter when the second training sample is the final training sample in the first sample set, and the error is greater than the first critical value.

14. The method of claim 13, wherein the applying the third training sample comprises:
amending the system to a second system; and
applying the third training sample to the second system.

15. The method of claim 14, wherein the system comprises a first input layer, a first fuzzy rules matching layer, and a first output layer, and the second system comprises a second input layer, a second fuzzy rules matching layer, and a second output layer.

16. The method of claim 13, further comprising:
generating a second error between an output of the system formed by the second system parameter and the third pre-known output value of the third training sample;
comparing the second error with a second critical value; and
applying the fourth training sample to the system formed by the second system parameter when the second error is not greater than the second critical value.

17. The method of claim 16, wherein the applying of the fourth training sample comprises:
creating a third system parameter when the second error is greater than the second critical value; and
applying the fourth training sample to the system formed by the third system parameter.

18. The method of claim 17, wherein the applying of the fourth training sample comprises:
amending the system to a second system having a different fuzzy rules matching layer from the system; and
applying the fourth training sample to the second system.

19. The method of claim 13, further comprising:
applying the third training sample to the system formed by the first system parameter when the second training sample is the final training sample in the first sample set, and the error is not greater than the first critical value.

20. A method in a self organizing learning Petri net, the method comprising:
forming a first system parameter from a first training sample;
applying a second training sample having a pre-known output value to a first system formed by the first system parameter to generate an output, the first system having a first fuzzy rules matching layer;
generating an error between the output of the system according to the second training sample and the pre-known output value of the second training sample;
comparing the error with a critical value; and
amending the first system to a second system when the error is greater than the critical value, the second system having a second fuzzy rules matching layer different from the first fuzzy rules matching layer of the first system.

21. The method of claim 20, wherein the amending of the first system comprises:
creating a second system parameter when the error is greater than the critical value; and
forming the second system according to the created second system parameter.

22. The method of claim 20, wherein the first fuzzy rules matching layer comprises a number of transitions and a number of places, and signals propagate based on the following Equation:
$$h ( {T}_{j} , t ) = exp ( - \frac{{\sum }_{i = 1}^{{n}_{1}} {( h ( {P}_{i , j} , t ) - {h}_{ij} )}^{2}}{{σ}_{j}^{2}} )$$
where hᵢⱼ is a firing weight on an arc between a place Pᵢⱼ and a transition Tⱼ, i is an index of a place connected to an input side of the transition Tⱼ, and h(Pᵢⱼ,t) is a value of a firing signal of the place at time t defined by a sum of values of the firing signal transferred by tokens in the place. When the place is empty, h(Pᵢⱼ,t) is given a value of zero. Exp( ) is an exponential function. In practical application, h(Tᵢⱼ,t) can be any kind of suitable nonlinear functions, and it is not limited just to exponential function.

23. The method of claim 22, wherein the first system comprises an output layer having a single transition and a single place to obtain a single output, and signals propagate based on the following Equation:
$$h ( {T}_{j} , t ) = \frac{{\sum }_{i = 1}^{{n}_{1}} h ( {P}_{i , j} , t ) \cdot {h}_{ij}}{{\sum }_{i = 1}^{{n}_{1}} h ( {P}_{i , j} , t )} .$$

24. The method of claim 23, wherein the first fuzzy rules matching layer comprises a minimum distance between the space and the transition based on the following equation:
$$D ( {\overline{H}}^{j} ( t ) , \overline{x} ) = {min}_{j - 1 , … , M} {d}^{j} ( \overline{H} ( t ) , \overline{x} )$$
where \overline{H}^{J}(t)=(h₁ⱼ(t), . . . ,h_{Qj}(t)), [and] Q is [the] a dimension of a current input \overline{x}, and d(•,•) is a metric distance.
